(19) United States
(12) Patent Application Publication
(10) Pub. No.: US 2025/0071513 A1
(43) Pub. Date: Feb. 27, 2025

(54) A WIRELESS COMMUNICATION DEVICE AND ASSOCIATED METHODS

(71) Applicant: Agsnesio Pty Ltd, East Wagga Wagga NSW (AU)

(72) Inventors: Daniel Grahame WINSON, Turvey Park NSW (AU); John LUCAS, Lake Albert NSW (AU); Paul MAYBON, Kooringal NSW (AU); Callum MAYBON, Kooringal NSW (AU); Neil PATERSON, Bridgewater SA (AU)

(21) Appl. No.: 18/727,026

(22) PCT Filed: Dec. 26, 2022
(86) PCT No.: PCT/AU2022/051596

§ 371 Date: Jul. 5, 2024

(30) Foreign Application Priority Data
Jan. 7, 2022 (AU) 20229000028

(51) Int. Cl. H04W 4/024; H04W 16/28; H04W 64/00

(52) U.S. Cl. CPC H04W 4/024; H04W 16/28; H04W 64/006

(57) ABSTRACT

A wireless communication device including a wireless communication system having a plurality of communication configurations. The device comprises a navigation system operable to generate navigation information including at least one of orientation information indicative of an orientation and position information indicative of a position. The device includes a processor operable to receive the navigation information and cause the wireless communication system to take a communication configuration previously determined for at least one of the orientation and the position.

### TECHNICAL FIELD

The present disclosure generally relates to wireless communication devices and associated methods, and particularly but not exclusively to a wireless communication device that is aware of at least one of its position and orientation and uses this awareness to improve communications.

### BACKGROUND

Wireless communication is the carriage of information by electromagnetic waves, for example electromagnetic waves having radio frequencies (which may be defined as frequencies in the range of 3 kHz to 1 GHz or more broadly 20 kHz to 300 GHz), microwave frequencies (1 GHz to 100 GHz), and optical frequencies (300 GHz to 770 THz). Uses for wireless communications include telecommunications, navigation, and entertainment. Examples of systems that use wireless communication include but are not limited to:
Wireless data networks—for example wireless mobile telecommunication networks, and Wi-Fi (IEEE 802.11) networks—which may enable telecommunications services, including data and telephony services.
Differential Global Positioning System (DGPS) systems—for example Real-time Kinematic Positioning (RTK) base stations—which may transmit a wireless navigation correction signal for improving satellite navigation precision.

In rural, regional or remote areas, however, the communication services may be patchy. Wireless signal strength may be marginal. This may be because, for example, base stations or transmitters in rural, regional and remote areas are sparse, or the topography interferes with wireless signals.

A wireless communication device—examples of which include but are not limited to wireless modems, cellular telephones, and satellite navigation receivers—may move between an area in which wireless communication is feasible and another area in which wireless communication is infeasible. Consequently, the wireless communication device may:
have intermittent access to a wireless signal
be unable to establish a network connection or network session
lose a network connection or network session
not have its transmission received.

Improved wireless communication in rural, regional and remote areas may enable and improve businesses, reduce isolation, increase safety, increase security, and improve navigation. There may be a demand for better wireless communications in a rural, regional or remote areas.

In the context of the present document, the meaning of wireless mobile telecommunication network encompass cellular network. Examples of cellular networks include but are not limited to networks using third generation (3G), Long Term Evolution (LTE), fourth generation (4G), and fifth generation (5G) wireless mobile telecommunication technologies.

### SUMMARY

Disclosed herein is a wireless communication device. The device comprises a wireless communication system having a plurality of communication configurations. The device comprises a navigation system operable to generate navigation information comprising at least one of orientation information indicative of an orientation and position information indicative of a position. The device comprises a processor operable to receive the navigation information and cause the wireless communication system to take a communication configuration previously determined for at least one of the orientation and the position.

In an embodiment, the wireless communication system can selectively connect to any one of a plurality of services. The processor may be operable to cause the wireless communication system to be in communication with a service of the plurality of services previously determined for at least one of the orientation and the position.

In an embodiment, the communication system comprises a plurality of dissimilarly orientated directional antennas, and the processor is operable to activate at least one directional antenna of the plurality of dissimilarly orientated directional antennas previously determined for at least one of the orientation and the position. A switch may be operationally coupled to the plurality of dissimilarly orientated directional antennas and operable to activate at least one of the plurality of dissimilarly orientated directional antennas. A controller may be operationally coupled to the switch and the processor for operating the switch in accordance with switching instructions received from the processor.

An embodiment comprises a beam-steering antenna. The processor may be operable to point the beam-steering antenna as previously determined for at least one of the orientation and the position.

In an embodiment, the communication system can selectively utilise a plurality of Quality of Service (QOS) policies. The processor may be operable to cause the wireless communication system to apply a QoS policy previously determined for at least one of the orientation and the position.

In an embodiment, the processor comprises memory comprising information indicative of which of the plurality of communication configurations to use at each of a plurality of locations.

An embodiment comprises a router comprising the processor and at least one wireless modem in information communication with the router.

In an embodiment, the wireless communication system is for wireless communication at a carrier frequency in the range of 27 MHz to 60 GHz. The wireless communication system may be for wireless communication at a carrier frequency in the range of 700 MHz to 3.5 GHz. The wireless communication system may be for wireless communication in at least one of a 3G frequency band, a 4G frequency band and a 5G frequency band.

In an embodiment, the processor is operable to receive the navigation information and cause a change of an electrical configuration of the wireless communication system so that it takes a communication configuration previously determined for at least one of the orientation and the position. Disclosed herein is a method for configurating a wireless communication device. The method comprises generating navigation information comprising at least one of orientation information indicative of an orientation and position information indicative of a position. The method comprises causing a wireless communication system to change to a communication configuration previously determined for at least one of the orientation and the position.

An embodiment comprises causing the wireless communication system to connect to a service of a plurality of services previously determined for at least one of the orientation and the position.

An embodiment comprises activating a directional antenna of a plurality of dissimilarly orientated directional antennas previously determined for at least one the orientation and the position.

An embodiment comprises pointing a beam-steering antenna as previously determined for at least one of the orientation and the position.

An embodiment comprises retrieving from memory information indicative of which of the plurality of communication configurations to use at each of a plurality of locations.

Disclosed herein is a method for receiving information in a wireless communication device, the information associating each of a plurality of communication configurations of the wireless communication device to a plurality of locations. The method comprises determining position information indicative of a position. The method comprises sending the position information. The method comprises receiving information indicative of which of the plurality of communication configurations to use at each of a plurality of locations including the position.

Disclosed herein is a method for generating communication configuration information. The method comprises the step of each of a plurality of wireless communication devices that are spatially distributed determining navigation information. The method comprises the step of each of the plurality of wireless communication devices determining a preferred communication configuration associated with their navigation information. The method comprises the step of each of the plurality of wireless communication devices sending navigation information and preferred communication configuration information associated with their navigation information to an information store.

Disclosed herein is non-transitory processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows a schematic diagram of an embodiment of a wireless communication device.

FIG. 2 is a simplified diagram of another embodiment of a wireless communication device mounted to a vehicle.

FIGS. 3 and 4 show the coverage of a first and a second cellular network over the same geographical areal.

FIG. 5 is a simplified diagram of still another embodiment of a wireless communication device mounted to a vehicle.

FIG. 6 shows a wiring diagram for a plurality of antennas and a modem.

FIG. 7 is a simplified diagram of yet another embodiment of a wireless communication device mounted to a vehicle.

FIGS. 8 to 10 each show a portion of the area around the road in FIGS. 3 and 4, and the vehicle with a wireless communications device mounted thereto at different points of a journey from A to B along the road.

FIG. 11 is a graphical representation of information indicative of which of a plurality of communication configurations to use at a plurality of locations when travelling from A to B.

FIG. 12 is another graphical representation of information indicative of which of a plurality of communication configurations to use at the plurality of location when travelling in the opposite direction, from B to A.

FIG. 13 is a simplified architectural diagram of a wireless communication device.

FIG. 14 is a more detailed architectural diagram of a wireless communication device.

FIG. 15 shows an example configuration of a information processing and information store system.

FIGS. 16 and 17 show flow charts for embodiments of a method for changing the communication configuration of a wireless communications device.

FIG. 18 shows a flow chart for an embodiment of a method for determining the preferred communication configuration for the current navigation information.

FIG. 19 is a flow chart of an embodiment for a method for refreshing the onboard communication configuration information.

FIG. 20 is a flow chart of an example method for changing a communication configuration.

### DESCRIPTION OF EMBODIMENTS

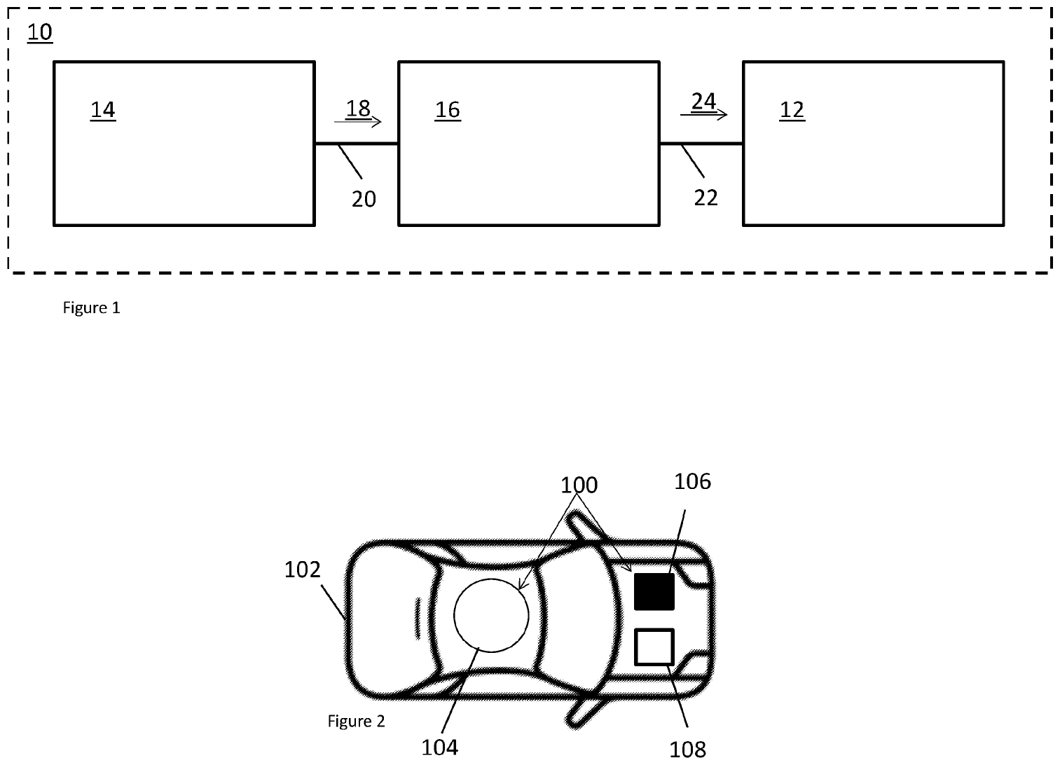

FIG. 1 shows a schematic diagram of an embodiment of a wireless communication device, which is generally indicated by the numeral 10. The device 10 comprises a wireless communication system 12 having a plurality of communication configurations. The device 10 comprises a navigation system 14 that can operate to generate navigation information 18 comprising at least one of orientation information indicative of an orientation of the wireless communication device and position information indicative of a position of the wireless communication device. The device 10 comprises a processor 16 that can operate to receive the navigation information 18 and cause the wireless communication system 12 to take a communication configuration previously determined for at least one of the orientation and the position.

That is, the device 10 is operable to be aware of one of its location (“location awareness”) and orientation (“orientation awareness”). Location awareness and orientation awareness are each types of navigational awareness. Being navigationally aware, the device 10 may be able to provide wireless communication that is better than prior art devices that are not navigationally aware.

In some adaptions of the device 10, the communication system 12 is in the form of a transceiver. The transceiver 12 is operable for communication with at least one of, for example, a wireless data network in the form of wireless mobile telecommunications network (e.g. 3G, 4G or 5G), an IEEE 802.11 network, a long range IEEE 802.11 network, a IEEE 802.16 network, a radio data network, a UHF network, a private LTE network, a public LTE network, and a private base station. The wireless communication system 10 is adaptable for wireless communication at a carrier frequency in the range of 27 MHz to 60 GHz, for example in the range of 700 MHz to 3.5 GHz or generally any suitable and desired range.

In some other adaptions of the device 10, the communication system 12 is in the form of a receiver. The receiver 12 can be operable for communication with, for example, a DGPS transmitter. The wireless communication system 12 can generally be for any form of wireless communication.

The processor 16 is in information communication with the navigation system 14 via communications channel 20. Communication channel 20 in the form of a cable carrying signals in accordance with a serial protocol (“serial connection”), and at a higher layer encompasses the AT (“Hayes”) command set protocol, however it may be any suitable form of communications channel. The navigation system 14 transmits the navigation information 18 to processor 16. The processor 16 receives the navigation information 18 transmitted by the navigation system 14.

The processor 16 is in information communication with the wireless communication system 12 via communications channel 22. The wireless communication channel 22 is in accordance with the IEEE 802.11n (“Wi-Fi”) specification, however generally any suitable communications channel 22 may be used. The processor 16 is operable to send communication configuration instructions 24 to the wireless transceiver system 12, which receives the communication configuration instructions 22. The wireless transceiver system 12 is operable to respond to a communications configuration instruction 24 by taking the communication configuration indicated by a received instruction.

More specifically, to change the communication configuration of the wireless communication system 12, the processor 16 can cause a change of an electrical configuration of the wireless communication system. Examples of changes of electrical configuration include:
switching a frequency filter configured to filter out a frequency, for example a frequency band when the frequency band is congested
switching an amplifier in the form of a power amplifier and/or a preamplifier, for example when signal strength is low
switching a multiplexer, for example a diplexer, when it is desired to combine signals at different frequencies.

Switching a component can include routing a signal through a component, arranging for a signal to bypassing a component, powering a component, depowering a component, or otherwise activating or deactivating a component, for example. When it is no longer required for a signal to be affected by a component, it may be beneficial to cause the signal to bypass the component to reduce signal degradation. The wireless communication system 12 can comprises the above mentioned components, or generally any suitable components, and associated electrical switches which are generally but not necessarily in the form of electronic switches.

FIG. 2 is a simplified diagram of another embodiment of a wireless communication device generally indicated by numeral 100, and which is mounted to a vehicle 102 in the form of a car (or automobile). The wireless communication device 100 has the parts shown in FIG. 1 which it shares with the wireless communication device 10 of FIG. 1, and parts that are similar or identical in form and/or function to those in FIG. 1 are similarly numbered. The wireless communication device 100 comprises at least one antenna 104 in the form of at least one omnidirectional antenna. The device 100 has a wireless communication system 12 in the form of a wireless transceiver system that comprises a plurality of transceivers 106,108 in the form of a plurality of wireless modems, that can each be in signal communication with the at least one antenna 104. The plurality of transceivers 106,108 are for a plurality of wireless services. For example a first transceiver 106 can be for a first cellular network service provided by a first service provider (for example, a 3G or 4G cellular network provided by one of TELSTRA, OPTUS, VODAFONE or generally any suitable provider) and a second transceiver 108 can be for a second cellular network service provided by a second service provider. The transceivers can be configured for exclusive use with a single one of the plurality of service providers (alternatively, a transceiver that can selectively use one of the plurality of wireless services may be used). The wireless communication system 12 of device 100 can use a suitable one of the plurality of transceivers 106,108 to connect to any of the plurality of wireless services. The processor 16 uses previously determined information stored in onboard memory indicating which service to use for the present position and/or orientation, and consequently which of the plurality of the plurality of transceivers to use. Activation of a transceiver 106,108 is achieved by an electrical switch in the form of a radio frequency (RF) switch and/or microwave frequency switch in communication with the plurality of transceivers 106,108 and the at least one antenna 104.

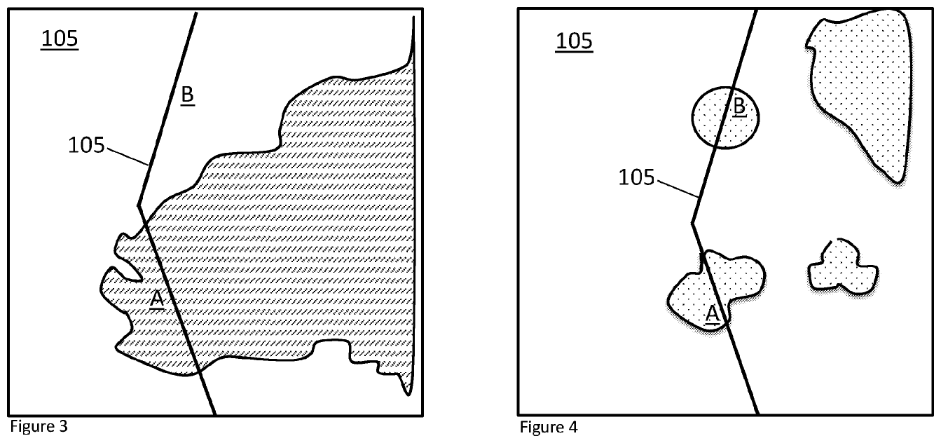

FIGS. 3 and 4 show the coverage of the OPTUS and TELSTRA cellular networks over the same area, which in this example is in rural New South Wales, Australia. The areas adjacent by points “A” and “B” are generally best serviced by the OPTUS cellular network and the TELSTRA cellular network respectively. When the processor 16 determines from the navigation information 18 that it is in area A (the area best served by OPTUS), it sends a transceiver configuration instruction to the wireless transceiver system 12 indicative of an instruction to activate transceiver 106 (the OPTUS modem). On receiving the instruction, the wireless transceiver system 12 makes transceiver 106 (the OPTUS modem) the active transceiver and makes transceiver 106 the deactivated transceiver. Conversely, when the processor 16 determines from the navigation information 18 that it is in area B (the area best served by TELSTRA), it sends a communication configuration instruction to the wireless transceiver system 12 indicative of an instruction to make transceiver 108 (the TELSTRA modem) the active transceiver and transceiver 106 the deactivated transceiver. This may enable communications over an area larger than would be possible using a single network. Activation and/or deactivation of a transceiver can be by, for example, routing a signal through a transceiver, arranging for a signal to bypassing a transceiver, powering a transceiver, depowering a transceiver, switching a transceiver, or otherwise activating or deactivating a transceiver, for example.

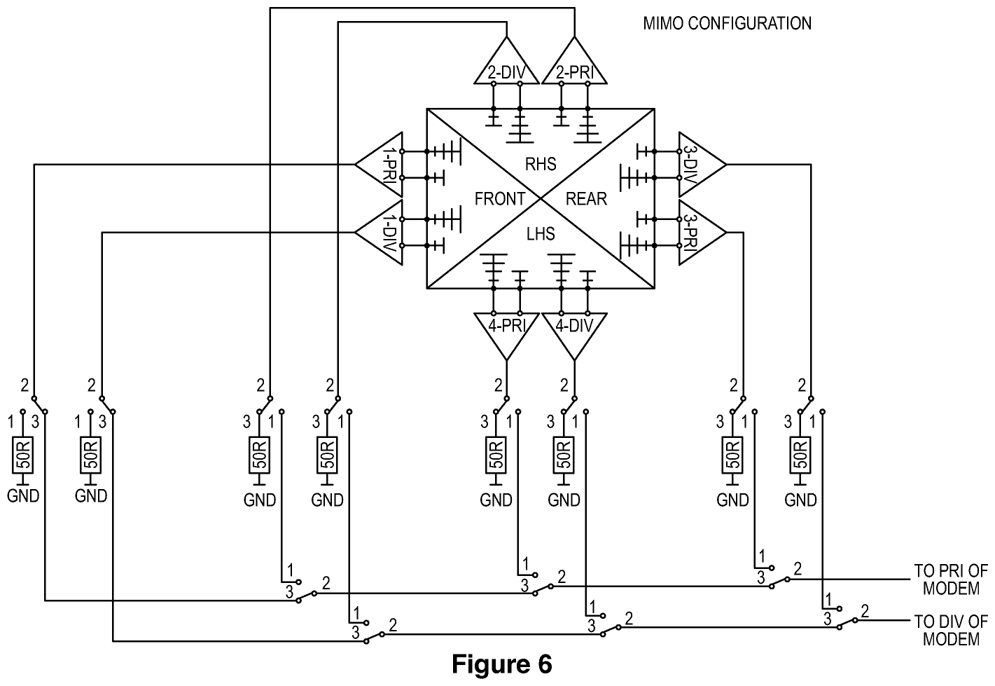

FIG. 5 is a simplified diagram of still another embodiment of a wireless communication device generally indicated by numeral 200 mounted to a vehicle 102 in the form of a car. The wireless communication device 200 has the parts shown in FIG. 1 which it shares with the wireless communication device 10 of FIG. 1, and parts that are similar or identical in form and/or function to those in FIGS. 1 and 2 are similarly numbered. The wireless communication device 200 comprises a plurality of dissimilarly orientated directional antennas 204-210. Each of the directional antennas 204-210 are for a different sector in the form of a different ninety degree sector, where antenna n is for sector n, where n is a positive integer. More or less sectors may be used as suitable and desired. For example, embodiments may have any of 2-10 or more sectors. Performance may improve with the number of sectors, but this may be at the expense of cost and simplicity. In the present but not all embodiments, the sectors fan out horizontally. The processor 16 is operable to activate one or more of the plurality of dissimilarly orientated directional antennas 204-210 previously determined for at least one of the orientation and the position of the wireless communications device 200. Consequently, a stronger signal for a particular location and orientation or heading can be achieved, which may improve wireless communications. FIG. 6 shows the wiring diagram for communication between the antennas 204-210 and the modem. Each of the four antennas 204-210 comprise two sets of two antenna elements, each being a Multiple Input and Multiple Output (MIMO) antenna. In an alternative embodiment, the antennas may be substituted for a beam-steering antenna, and the processor 16 operable to point the beam-steering antenna as previously determined for at least one of the orientation and the position.

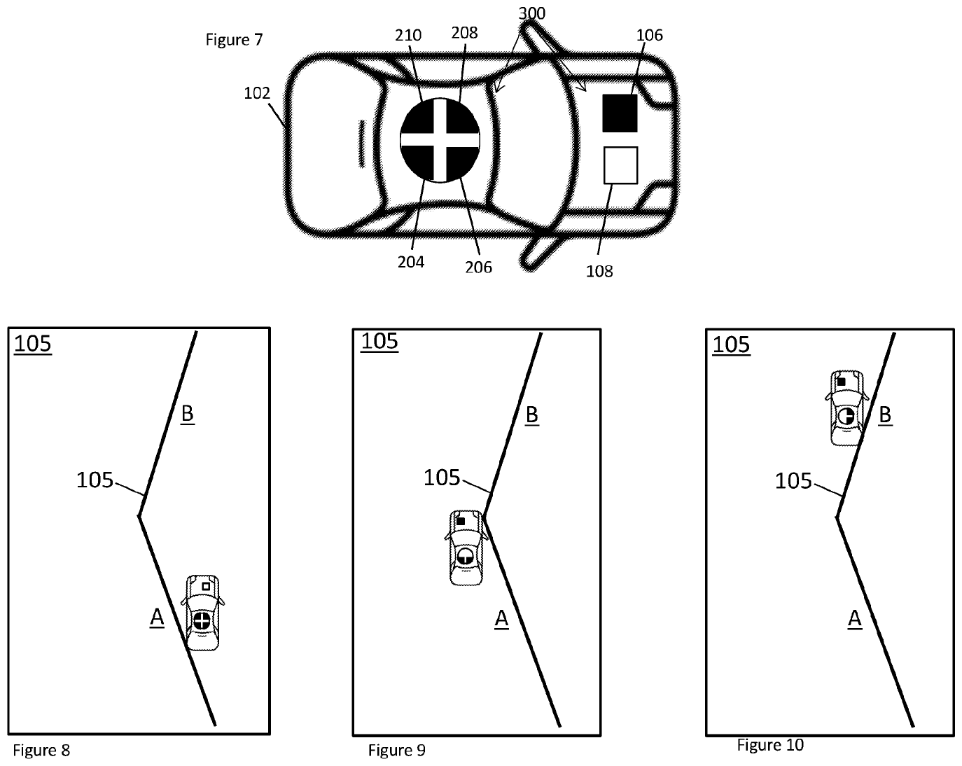

While wireless communications device 100 can select between service providers for best reception but not wireless direction, and wireless communication device 200 can select between the plurality of dissimilarly orientated direction antennas 204-210 for the best reception but not service provider, another embodiment can select both service provider and wireless direction, which may improve wireless communications further. FIG. 7 shows another embodiment of a wireless communication device generally indicated by the numeral 300 mounted to a vehicle 102 in the form of a car. The wireless communication device 300 has the parts shown in FIG. 1 which it shares with the wireless communication device 10 of FIG. 1, and parts that are similar or identical in form and/or function to those in FIGS. 1, 2 and 5 are similarly numbered. The processor 16 is operable to activate one or more of the plurality of dissimilarly orientated directional antennas 204-210 previously determined for at least one of the orientation and the position of the wireless communications device 200, and which transceiver 106, 108 to use as previously determined for at least one of the position and orientation. Consequently, the antenna can be pointed to a cellular base station—for either one of the two services-providing an improved signal for a particular location and orientation, which may improve wireless communications.

FIGS. 8 to 10 shows the area 105, and the vehicle 102 with wireless communications device 300 mounted thereto at different points of a journey from A to B along the road 107. In FIG. 8, the vehicle is at A and the wireless communications device 300 has activated the TELSTRA modem and directional antenna for sectors 1 to 4. In FIG. 9, the vehicle is intermediate A and B, and the wireless communications device 300 has activated the OPTUS transceiver and directional antennas for sectors 2 and 3. In FIG. 10, the vehicle is approaching area B, and the OPTUS modem is still active and the wireless communications device 300 has activated directional antennas for sectors 1 and 2. The processor 16 of the wireless communications device 300 comprises memory comprising information indicative of which of the plurality of communication configurations to use at each of a plurality of locations and orientations, the information having being previously determined.

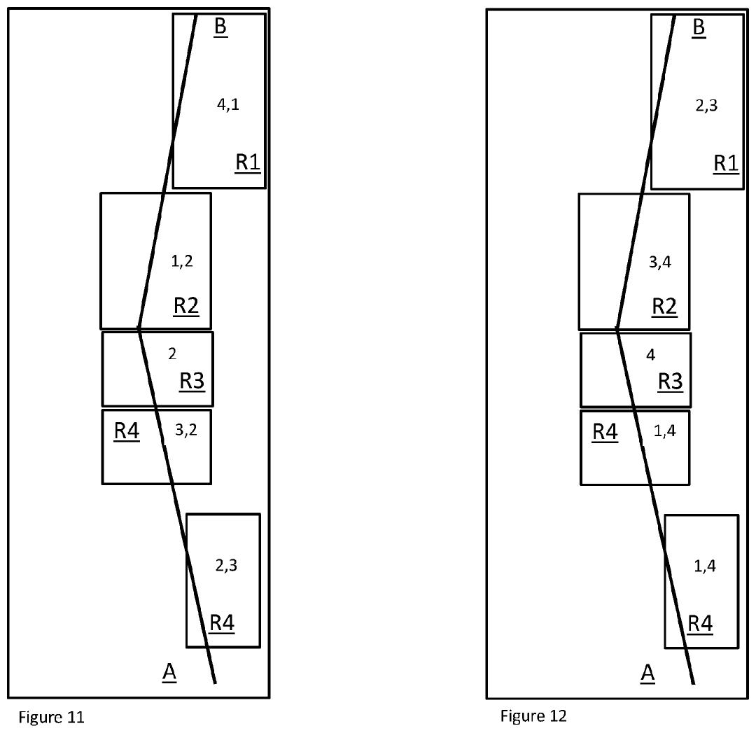

FIG. 11 is a graphical representation of the information indicative of which of the plurality of communication configurations to use at a plurality of regions R1 to R4 when travelling from A to B. FIG. 12 is another graphical representation of the information indicative of which of the plurality of communication configurations to use at the plurality of location when travelling in the opposite direction, from B to A. The information defines five regions defined by polygons in the form of rectangles. The active sectors in each of the five regions are numerically indicated in each rectangle. Also associated with each of the five regions is information indicating which service provider to connect to. The information is summarised in Table A.

TABLE A
Summary of an example of communication
configuration information.

| Orientation | Region | Antenna sectors active | Service provider |
|---|---|---|---|
| Travelling A to B | R1 | 1, 4 | TELSTRA |
| Travelling A to B | R2 | 1, 2 | OPTUS |
| Travelling A to B | R3 | 2 | OPTUS |
| Travelling A to B | R4 | 2, 3 | OPTUS |
| Travelling A to B | R5 | 2, 3 | TELSTRA |
| Travelling B to A | R1 | 2, 3 | TELSTRA |
| Travelling B to A | R2 | 3, 4 | OPTUS |
| Travelling B to A | R3 | 4 | OPTUS |
| Travelling B to A | R4 | 1, 4 | OPTUS |
| Travelling B to A | R5 | 1, 4 | TELSTRA |

The processor 16 uses position and orientation information to determine which region it is in and its orientation, and subsequently retrieves the corresponding communication configuration information from the onboard memory for configuring the transceiver system 12.

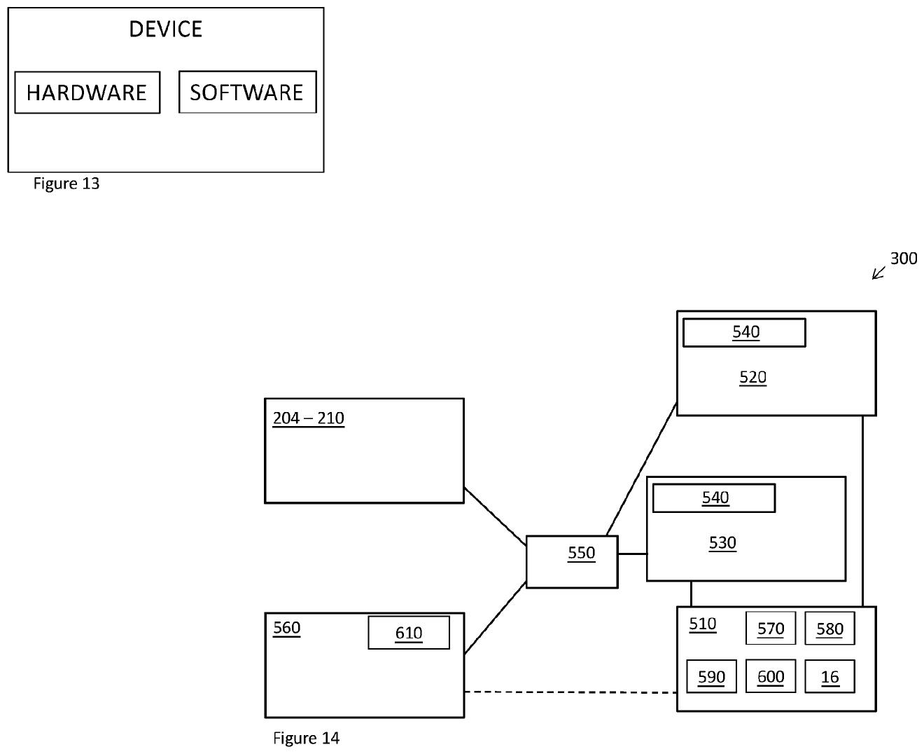

FIG. 13 is a simplified architectural diagram of the wireless communication devices 10, 100, 200 and 300, showing that the device comprises hardware and software, however other embodiments may be purely hardware based. FIG. 14 is a more detailed architectural diagram of the wireless communication device 300. The router 510 comprises the processor 16. An example of a suitable router 510 is a MIKROTIK router, which incorporates a processor in the form of a MediaTek MT7621A Wi-Fi SoC, however generally any suitable router may be used. The router 510 is in communication via a serial cable to modems 520,530, which include removable Subscriber Identity Modules (SIMs) for a plurality of mobile wireless data networks (OPTUS and TELSTRA, for example). The modems 520,530 include a satellite navigation receiver (GPS) 540 for determining navigation information comprising position and/or orientation information. The modems 520,530 are in the form of a Quectel Wireless EP06-E 4G modem, however generally any suitable modem may be used. Orientation information can be determined by monitoring the change in position over time, by a separate magnetic compass module, a gyroscope, or generally any suitable way. The directional antennas 204-210 are in communication with the modems 520,530 via electrical conduit in the form of coaxial cable and an electrical switch 550 in the form of a radio frequency (RF) switch and/or microwave frequency switch. The electrical switch 550 can connect any combination of the antennas 204-210 with any one of the plurality of modems 520, 530. The electrical switch 550 is controlled by a switch controller 560 in communication with the electrical switch 550 via a serial channel using the I2C serial protocol. The switch controller 560 is in communication with the router 510 via a Wi-Fi channel, allowing the processor 16 in the router 500 to instruct the switch controller 560 to configure the electrical switch to connect which antenna(s) 204-210 to connect to which modem 520,530. The switch controller 560 comprises a microcontroller unit (MCU) with integrated Wi-Fi and Bluetooth connectivity in the form of an ESP32 MCU manufactured by ESPRESSIF.

The router 510 includes the following software in onboard memory:
Navigation Software 570 when executed by the processor 16 can cause the device 300 to retrieve the navigation information from the satellite navigation module 540 (and optionally a compass module) and pass it to communication configuration Software 580.
Communication configuration Software 580 when executed by the processor 16 causes the device 300 to retrieves communication configuration information from a remote computer server system when required. The communication configuration information retrieved is for an area that encompasses the current location, and generally extends beyond it. The communication configuration software 580 when executed by the processor 16 also can cause the device 300 to pass communication configuration information indicative of communication configuration for the current navigation information to the RF Control software.
Quality of Service Software 590 defines a Quality of Service (QOS) policy for the configuration information for the current location. This may generally be any suitable QOS policy. When executed by the processor 16, the QOS software can cause the device 300 to [Dan: Please explain what happens when the QOS software is executed].
Testing Software 600 when executed by the processor 16 can cause the device 300 to control routing, QOS and radio frequency and/or microwave switching during testing to ensure end user access is maintained during testing, controls testing process, and passes the test results to the cloud.

The switch controller 560 includes the following software in onboard memory:
RF Control Software 610, which when executed by the switch controller 500 can cause the device 300 to store at least one list of communication configurations, retrieves communication configuration information from the communication configuration software 580 and sends a control signal to the electrical switch 550 to set the communication configuration.

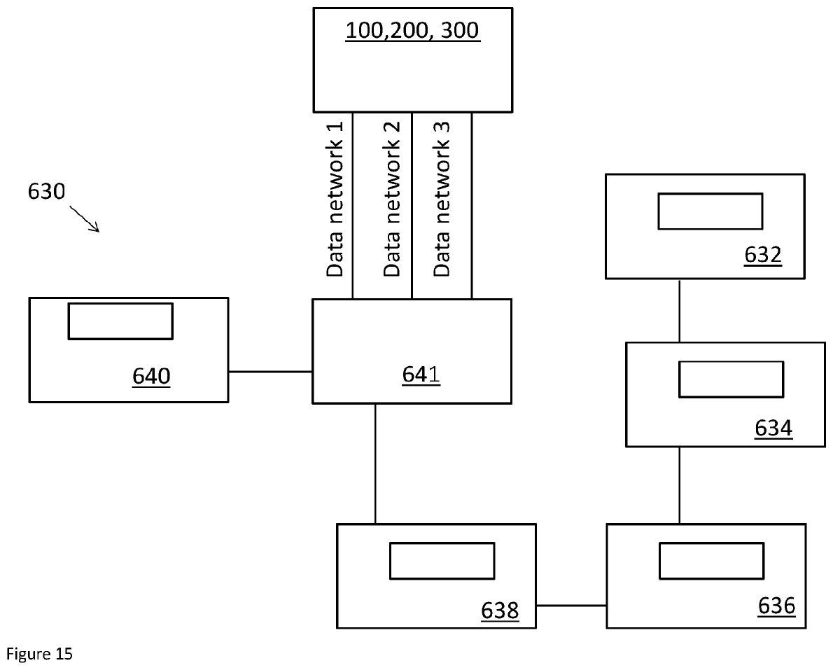

As disclosed above, the communication configuration software 580 when executed can cause the device 300 to retrieve communication configuration information from a remote information processing and information store system 630 in the form of computer server system 630, an example configuration of which is shown in FIG. 15. The communication configuration software 580 when executed can cause the device 300 to determine position information indicative of its current position. The communication configuration software 580 can cause the device 300 to send the position information to the remote computer server system 630. The communication configuration software 580 receives information indicative of which of the plurality of communication configurations to use at each of a plurality of locations and/or orientations including the current position and/or orientation.

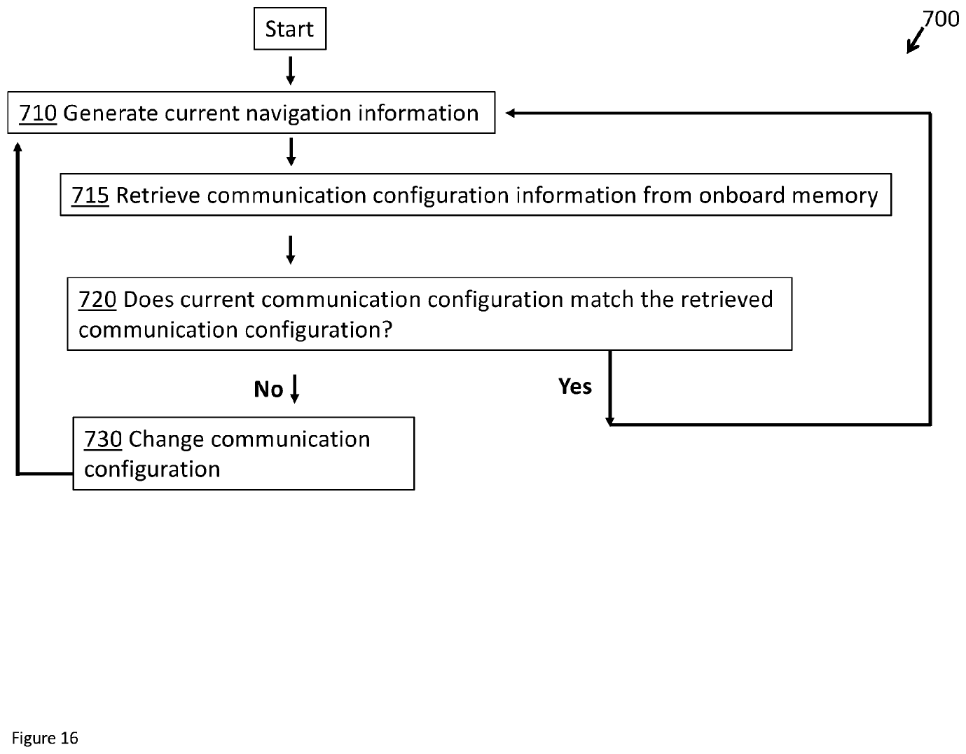

FIG. 16 is a flow chart of an embodiment of a method 700 for changing the communication configuration of a wireless communications device 10,100,200,300. Software stored in onboard memory when executed by the processor 16 causes the device to perform the embodiment 700. The method embodiment 700 may be used to improve communication with a wireless data network or DGPS, for example. Embodiments of wireless communications devices that are similar or identical to wireless communication devices 10, 100, 200 and 300, for example, can perform the steps shown in flow chart 700. In 710, current navigation information is generated, wherein for example the satellite navigation receiver 540 generates position information indicative of the current position and optionally a compass module generates orientation information indicative of the current orientation. In 715, communication configuration information for the current navigation information is retrieved from onboard memory. In 720, it is determined whether the current communication configuration of the wireless communications system matches the retrieved communication configuration. If yes, then we return to step 710, otherwise in step 730 the communication configuration is changed to that of the communications information retrieved in step 715. Provided that the needed communication configuration information is in onboard memory, execution of method embodiment 700 may provide improved communications.

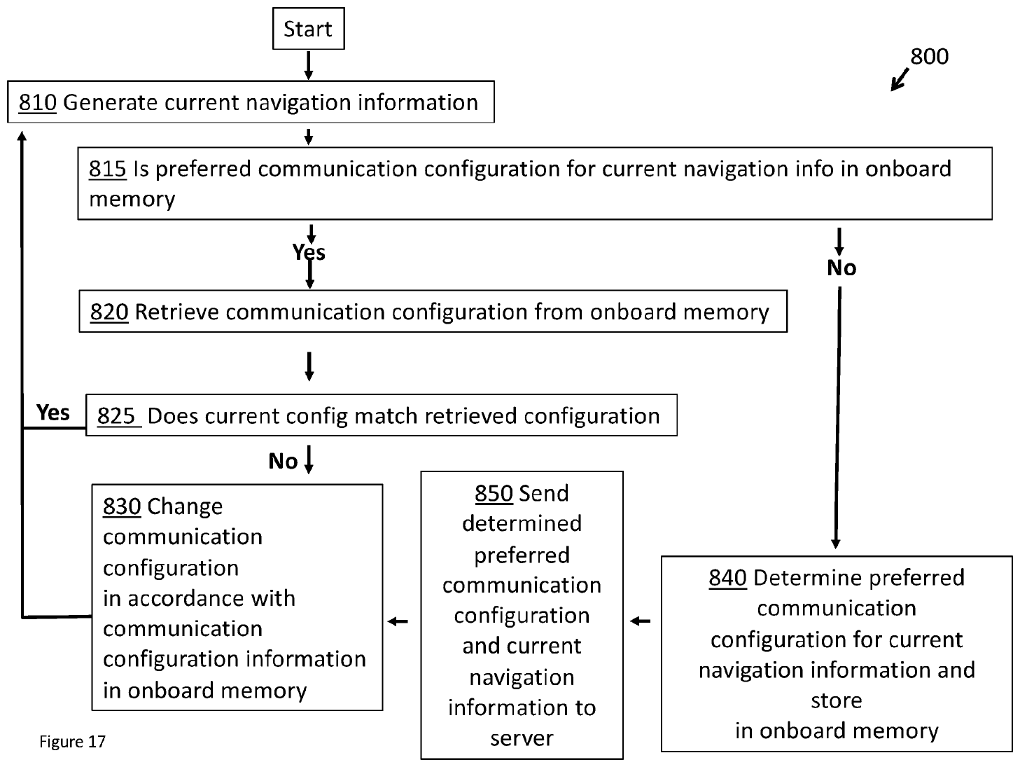

Sometimes, however, the required communication configuration information is not in onboard memory or is incomplete. For example, the vehicle may have left an area for which the onboard memory has corresponding communication configuration information, or the vehicle has turned down a minor road for which the preferred communications configuration has not yet been determined. FIG. 17 is a flow chart of another embodiment of a method 800 for changing the communication configuration of a wireless communications device 10,100,200,300. Software stored in onboard memory when executed by the processor 16 causes the device to perform the embodiment 800. The method embodiment 800 may be used to improve communication with a wireless data network, for example. Embodiments of wireless communications devices that are similar or identical to wireless communication devices 10, 100, 200 and 300, for example, can optionally perform the steps shown in flow chart 800. In step 810, current navigation information is generated, wherein for example the satellite navigation receiver 540 generates position information indicative of the current position and optionally a compass module generates orientation information indicative of the current orientation. In 815, it is determined whether the communication configuration for the current navigation information is in on board memory. If yes, in step 820 the communications configuration information is retrieved from on board memory. In 825 and 830, it is determined whether the current communications configuration needs to be changed to match the configuration information for the current navigation information (that is, the determined configuration), and if so it is changed. If in step 815 it is determined that the communication configuration for the current navigation information is not in onboard memory, then in step 840 the system determines the preferred communications configuration for the current navigation information and stores it in the device's onboard memory. This can include, for example, running one or more tests to select a preferred communication configuration for the current navigation information. Alternatively, it can electronically retrieve this information from information store 620. Alternatively, it may electronically retrieve configuration information from the information store 620 and use the retrieved configuration information in addition to test results to determine the preferred communication configuration. In step 850, the determined preferred communications configuration and current navigation information is optionally sent to the information store 620 for associated storage therein for future use. The embodiment of method 800 may be used to improve communication with a wireless data network, for example.

Current navigation information refers to the location, heading or other location specific information used to represent the present physical status of the environment surrounding the device 10,100,200,300.

Current configuration refers to the communications configuration that is actively applied.

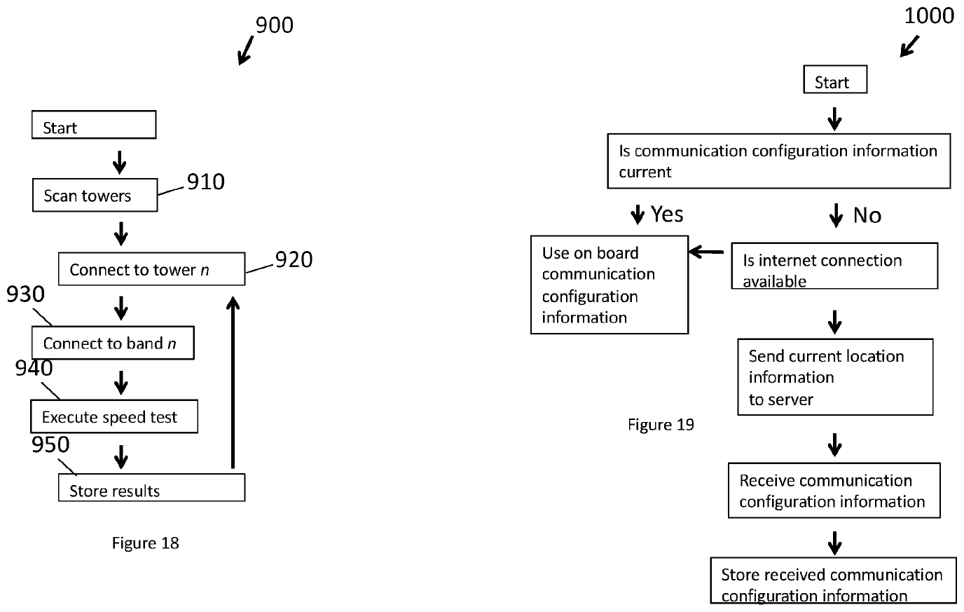

The determined preferred communications configuration is the selected communications configuration for the current navigation information. Determining the preferred communications configuration for the current navigation information can include at least one test, which can include for example scanning for base stations, trying different communication frequency bands, measuring wireless signal strength, connecting to a wireless data service and running speed, latency and drop packet tests. The results are likely to be different for different times (e.g. different days of the week/years and different times during the day). The navigation information can optionally include time information indicative of the current time. The communication configuration information can optionally change depending on time in accordance to network forecasts. FIG. 18 is a flow chart 900 for an embodiment of a method for determining the preferred communication configuration for the current navigation information. One step 910 comprises scanning for transmitters in the form of base stations or towers. A connection is made to each found tower (920) on each band (930) and a test in the form of a speed test is performed (940). The results of the test are stored (950).

FIG. 18 is a flow chart 1000 of an embodiment for a method for refreshing the communication configuration information (“config map”).

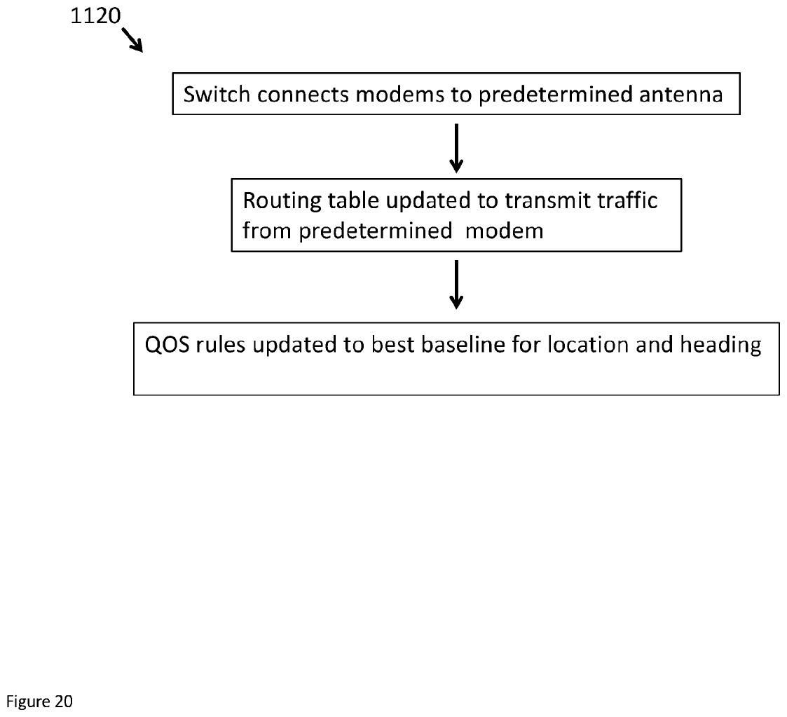

FIG. 20 is a flow chart 1120 of an example method for changing a communication configuration, for an embodiment of a device including a plurality of transceivers capable of passing TCP/IP traffic (for example, multiple 4G modems) and a plurality of antennas.

Changing the communication configuration can include at least one of:
An electrical circuit electronically modified to improve the signal received by various transceivers from one or more antenna elements.
Routing table updates to select a particular path for particular classes of traffic.
Quality of Service (QOS) policies applied to slow, drop or block some types of traffic with the goal of prioritising other types of traffic.

The remote computer server system 630 can generally comprise one or any suitable combination of more than one physical computer servers, and may comprise virtual servers, or be provided by a cloud service, for example Amazon Web Services. The device 10, 100, 200, 300 is operable to communicate with the remote computer server system via a wireless data networks, for example the cellular network it is connected to or a Wi-Fi network if available. In these but not necessarily in all embodiments, a virtual point-to-point connection that tunnels through the wireless data network is established using Virtual Private Network technology, which connects the device 10,100,200,300. FIG. 15 shows a schematic diagram on an example architecture of the remote computer system 620. Included is a VPN server 640 and a gateway server 641.

The remote server system 620 can include the following software:
Raw information software 632
The information lake of remote computer server system 620 is capable of receiving and/or retrieving information from systems in a raw, or unstructured or largely unstructured format (for example, a comma separated volume), that is not yet suitable for use as a source of information by other processes. Devices that undertake a range of passive logging and active testing send stored results in the information lake.
Transformed information software 634
The information transformation process received the raw information from the information lake and transforms it into a structured format, for example a relational database or NOSQL database that is suitable for use within other processes, such as the Config Generator.
Config Generator software 636
The config generator creates and stores details of possible preferred communication configurations using the information collected by devices.
ConfigMaps software 638
ConfigMaps stores and makes available communication configurations that are associated with navigation information to enable devices to rapidly select optimal communication configurations.
Routing Software
Routing functionality enables information to be sent to the internet in order to maintain stable TCP/UDP sessions. For example, by tunnelling both Telstra and Optus to the cloud before launching a Wi-Fi call it is possible to maintain the Wi-Fi call while roaming across Telstra and Optus.

The base station or repeater may be on a vehicle. For example, a tractor may be carrying a base station and a wireless communication device 10, 200, 200, 300 on a ute or other vehicle may be in communication with the base station or repeater. The communications configuration information stored in onboard memory may be updated when the tractor moves.

Now that embodiments have been described, it will be appreciated that some embodiments may have some of the following advantages:
Embodiments may provide users of a telecommunication service with at least one of improved service availability and service quality. For example, a user moving through an area with patchy cellular network coverage—for example in a rural, regional or remote area—may experience better service availability and quality when using embodiments disclosed herein than the prior art.
Multiple service providers may be used to increase coverage.
Information for the preferred communication configurations may be collected over time by many vehicles with an onboard embodiment (“crowd sourced” information), which may be a better way to collect the communication configuration information and keep it updated.
Embodiments may be relatively easy to install.
Interference may be reduced.
Embodiments may be mounted backwards but the orientation information makes mounting orientation flexible.
Device 100 may reduce the need for multiple big antennas to access more than one wireless network, reduce cost, reduce install complexity and reduce interference.
Devices 200 and 300 may increase performance by using higher gain directional antennas.
There are no moving parts that would require frequent maintenance and be susceptible to breaking down.

Variations and/or modifications may be made to the embodiments described without departing from the spirit or ambit of the invention. For example:
While specific types of communication channels have been specified, communication channels may be analogue, digital, serial, parallel, wired or wireless, or generally any combination of these, as suitable and as desired. Any suitable and designed communication channels may be used.
The wireless communication system may be mounted to generally any suitable machinery, examples of which include but are not limited to vehicles, automobiles, farm machinery (including tractors), trucks, four-wheel drives, utility vehicles, light commercial vehicles with open cargo beds (“utes”), motorbikes, locomotives and carriages, military armoured vehicles and tanks, boats, aircraft, and go-carts.
The wireless services may generally be any suitable wireless services, for example wireless data networks, cellular networks, Wi-Fi networks, and Differential Global Positioning networks.
The sectors may fan out in a direction other than horizontally, for example be inclined relative to the horizontal.
The navigation information may include additional information for setting the communication configuration. The additional information may be pitch information indicative of the pitch of a wireless communications device and roll information indicative of the roll of the wireless communications device, the information being generated by an onboard triple-axis accelerometer.
Embodiments may have three or more transceivers for three or more network service providers, and be able to switch between the network service providers.
Instead of multiple directional antennas, there may be a single directional antenna that is pointed by an electric motor.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A wireless communication device, the device comprising:
a wireless communication system having a plurality of communication configurations;
a navigation system operable to generate navigation information comprising at least one of orientation information indicative of an orientation and position information indicative of a position; and
a processor operable to receive the navigation information and cause the wireless communication system to take a communication configuration previously determined for at least one of the orientation and the position;
wherein taking the communication configuration comprises at least one of:
switching a frequency filter configured to filter out a frequency;
switching an amplifier;
switching a multiplexer;
electronically modifying an electrical circuit to improve the signal received by a plurality of transceivers from at least one antenna element;
switching a plurality of antennas between a plurality of transceivers.

2. The device defined by claim 1, wherein the wireless communication system can selectively connect to any one of a plurality of services and the processor is operable to cause the wireless communication system to be in communication with a service of the plurality of services previously determined for at least one of the orientation and the position.

3. The device defined by claim 1, wherein the communication system comprises a plurality of dissimilarly orientated directional antennas, and the processor is operable to activate at least one directional antenna of the plurality of dissimilarly orientated directional antennas previously determined for at least one of the orientation and the position.

4. The device defined by claim 3, comprising a switch operationally coupled to the plurality of dissimilarly orientated directional antennas and operable to activate at least one of the plurality of dissimilarly orientated directional antennas.

5. The device defined by claim 4, comprising a controller operationally coupled to the switch and the processor for operating the switch in accordance with switching instructions received from the processor.

6. The device defined by claim 1, comprising a beam-steering antenna, and the processor is operable to point the beam-steering antenna as previously determined for at least one of the orientation and the position.

7. The device defined by claim 1, wherein the processor is operable to cause the wireless communication system to apply a quality of service policy previously determined for at least one of the orientation and the position.

8. The device defined by claim 1, wherein the processor comprises memory comprising information indicative of which of the plurality of communication configurations to use at each of a plurality of locations.

9. The device defined by claim 1, comprising a router comprising the processor and at least one wireless modem in information communication with the router.

10. The device defined by claim 1, wherein the wireless communication system is for wireless communication at a carrier frequency in the range of 27 MHz to 60 GHz.

11. The device defined by claim 10, wherein the wireless communication system is for wireless communication at a carrier frequency in the range of 700 MHz to 3.5 GHz.

12. The device defined by claim 10, wherein the wireless communication system is for wireless communication in at least one of a 3G frequency band, a 4G frequency band and a 5G frequency band.

13. The device defined by claim 1, wherein the wireless communication system comprises at least one omnidirectional antenna.

14. A method for configurating a wireless communication device, the method comprising:
generating navigation information comprising at least one of orientation information indicative of an orientation and position information indicative of a position; and
causing a wireless communication system to change to a communication configuration previously determined for at least one of the orientation and the position, wherein changing to the communication configuration comprises at least one of:
switching a frequency filter configured to filter out a frequency;
switching an amplifier;
switching a multiplexer;
electronically modifying an electrical circuit to improve the signal received by a plurality of transceivers from at least one antenna element;
switching a plurality of antennas between a plurality of transceivers.

15. The method defined by claim 14, comprising causing the wireless communication system to connect to a service of a plurality of services previously determined for at least one of the orientation and the position.

16. The method defined by claim 14, comprising activating a directional antenna of a plurality of dissimilarly orientated directional antennas previously determined for at least one of the orientation and the position.

17. The method defined by claim 14, comprising pointing a beam-steering antenna as previously determined for at least one of the orientation and the position.

18. The method defined by claim 14, comprising retrieving from memory information indicative of which of the plurality of communication configurations to use at each of a plurality of locations.

19-20. (canceled)

21. Non-transitory processor readable tangible media including program instructions which when executed by a processor causes the processor the perform the method defined by claim 14.

22. A computer program for instructing a processor, which when executed by the processor causes the processor to perform the method defined by claim 14.

23-26. (canceled)
